(19) United States
(12) Patent Application Publication
(10) Pub. No.: US 2025/0066661 A1
(43) Pub. Date: Feb. 27, 2025

(54) INVERTING PACKAGES, EMULSIONS, AND METHODS

(71) Applicant: Sterling Specialty Chemicals Holding UK Limited, Harrow (GB)

(72) Inventors: Hong Yang, Norcross, GA (US); Shradha Patil, Smyrna, GA (US); Ronald Robinson, Newnan, GA (US); Roopa Tellakula, Suwanee, GA (US)

(21) Appl. No.: 18/804,760

(22) Filed: Aug. 14, 2024

Related U.S. Application Data
(60) Provisional application No. 63/578,490, filed on Aug. 24, 2023.

(30) Foreign Application Priority Data
Sep. 21, 2023 (FI) 20236048

(51) Int. Cl. C09K 8/68

(52) U.S. Cl. CPC C09K 8/68; C09K 2208/28

(57) ABSTRACT

Compositions, such as emulsions, that include water, a hydrophobic liquid, a polymer, and a breaker. Inverting packages that include a breaker. The breaker may include a tallow amine ethoxylate. The polymer may include a repeat unit that includes a sulfonic acid moiety or a sulfonate moiety. Inverted emulsions and treatment fluids that include inverted emulsions. Methods of treating subterranean formations with treatment fluids.

### FIELD OF THE DISCLOSURE

This disclosure relates to inverting packages, emulsions, such as inverse emulsions, that include inverting packages, methods of inverting emulsions, and methods of using inverted emulsions in one or more applications, such as friction reduction in oil recovery operations.

### BACKGROUND

Efforts have been made to devise high viscosity friction reducers (HVFRs), especially HVFRs that are effective at relatively low dosages. HVFRs can be useful in a number of applications and industries, including the oil and gas industry.

Some HVFRs have been made by dewatering inverse emulsions, and these HVFRs have been used in place of the inverse emulsions for one or more reasons. Some HVFRs have been made by dewatering an inverse emulsion, and adding an anionic polyacrylamide, which may be in the form of a ground powder. Some HVFRs have been made by dewatering an emulsion, and incorporating a sulfonated monomer, such as acrylamide t-butyl sulfonic acid (ATBS), which may exhibit relatively high standard viscosity, good salt-tolerant properties in oil field brines (produced water), or a combination thereof.

These HVFRs, however, can be disadvantageous for one or more reasons, especially the HVFRs that include a sulfonated monomer. For example, the inverting of the HVFRs may be insufficient within a short period of time after contacting field brines, which can cause low friction reduction.

There remains a need for HVERs having improved inverting efficiency.

### BRIEF SUMMARY

Provided herein are HVFRs having improved inverting efficiency, including HVFRs that (i) are formed by dewatering an inverse emulsion and/or (ii) include a sulfonated monomer, such as ATBS. The HVFRs provided herein may include a breaker that includes one or more inverting surfactants, wherein a tallow amine ethoxylate is present at an amount of at least 30 wt %, based on the weight of the breaker. The HVFRs provided herein may achieve a higher friction reduction compared to those featuring a breaker that does not include at least 30 wt % of a tallow amine ethoxylate.

In one aspect, compositions, such as emulsions (e.g., inverse emulsions), are provided. In some embodiments, the compositions include water, a hydrophobic liquid, a polymer, and a breaker. The breaker may include one or more inverting surfactants, and the one or more inverting surfactants may include a tallow amine ethoxylate. The tallow amine ethoxylate may be present in the breaker at an amount of at least 30% (e.g., at least 50%), by weight, based on the weight of the breaker. The breaker may be present in the emulsions at an amount of about 1% to about 50%, by weight, based on the weight of the emulsions. The polymer may be a homopolymer or a copolymer, and may include a repeat unit that includes a sulfonic acid moiety or a sulfonate moiety.

In a further aspect, inverting packages are provided. The inverting packages may include a breaker, as described herein. In some embodiments, the breaker includes tallow amine ethoxylate at an amount of at least 50%, by weight, based on the weight of the breaker.

In another aspect, inverted emulsions are provided. In some embodiments, the inverted emulsions include a composition, such as an inverse emulsion, as described herein, and an additional amount of water. The water of the composition and the additional amount of water may be the same type of water or different types of water. The polymer may be present in the inverted emulsion at a concentration of about 50 ppm to about 15,000 ppm.

In yet another aspect, methods of treating a subterranean formation, such as a mineral oil deposit, are provided. In some embodiments, the methods include providing a treatment fluid that includes any of the inverted emulsions described herein; and injecting the treatment fluid into the subterranean formation.

Additional aspects will be set forth in part in the description which follows, and in part will be obvious from the description, or may be learned by practice of the aspects described herein. The advantages described herein may be realized and attained by means of the elements and combinations particularly pointed out in the listing of embodiments and the appended claims. It is to be understood that both the foregoing general description and the following detailed description are exemplary and explanatory only and are not restrictive.

### BRIEF DESCRIPTION OF THE DRAWINGS

FIG. 1 depicts a plot of friction reduction percentage v. time for embodiments of compositions herein.

FIG. 2 depicts a plot of viscosity v. shear rate for embodiments of compositions herein.

FIG. 3 depicts a plot of friction reduction percentage v. time for embodiments of compositions herein.

FIG. 4 depicts a plot of viscosity v. shear rate for embodiments of compositions herein.

### DETAILED DESCRIPTION

Provided herein are inverting packages, and emulsions that include the inverting packages. The emulsions herein may include inverse emulsions, dewatered emulsions, and inverted emulsions. An emulsion, such as an inverse emulsion or dewatered inverse emulsion may include water, a hydrophobic liquid, a polymer that includes two or more different repeat units, and a breaker that includes one or more inverting surfactants. An inverted emulsion may include an inverse emulsion or dewatered emulsion, and an additional amount of water.

### Breaker/Tallow Amine Ethoxylate

The compositions provided herein may include a breaker. The breaker may include one or more inverting surfactants. The one or more inverting surfactants may include a tallow amine ethoxylate. A breaker generally may include any amount of a tallow amine ethoxylate. In some embodiments, a tallow amine ethoxylate is present in a breaker at an amount of at least 50%, at least 60%, at least 70%, at least 80%, at least 90%, or at least 95%, by weight, based on the weight of the breaker.

A composition that includes a breaker, as provided herein, may include any amount of a tallow amine ethoxylate. A tallow amine ethoxylate, in some embodiments, is present in a composition at an amount of about 1% to about 15%, about 2.5% to about 15%, about 1% to about 10%, about 2.5% to about 10%, or about 2.5% to about 5%, by weight, based on the weight of the composition.

In some embodiments, the breaker consists of a tallow amine ethoxylate. In some embodiments, the breaker includes a tallow amine ethoxylate and one or more other inverting surfactants. The one or more other inverting surfactants may include any of those known in the art, such as those described in U.S. Pat. No. 10,899,955, which is incorporated by reference herein. As used herein, the phrase “inverting surfactant” refers to a molecule or composition that may facilitate the inverting of an emulsion. The one or more other inverting surfactants may be selected from those having a hydrophilic-lipophilic balance (HLB) of greater than 10. The one or more other inverting surfactants may include, but are not limited to, polyoxyethylene sorbitol tetraoleate; polyethylene glycol monoleate; ethoxylated alcohols, such as C₁₂₋₁₄ branched ethoxylated alcohol, ethoxylated octyl and nonyl phenols; ethoxylated nonyl phenol formaldehyde resin; polyethylene oxide esters of fatty acids; dioctyl esters of sodium sulfosuccinate; and other inverting surfactants disclosed in U.S. Pat. No. 3,624,019, which is incorporated by reference herein.

A breaker may be present in a composition, such as an emulsion, at any desirable amount. In some embodiments, the breaker is present in a composition at an amount of about 1% to about 50%, about 1% to about 40%, about 2.5% to about 40%, about 1 to about 30%, about 2.5% to about 30%, about 1% to about 20%, about 2.5% to about 20%, about 1% to about 15%, about 2.5% to about 15%, about 1% to about 10%, about 2.5% to about 10%, about 1% to about 5%, about 2.5% to about 5%, or about 1% to about 3%, by weight, based on the weight of the composition. Whether a breaker includes only a tallow amine ethoxylate, or a tallow amine ethoxylate and one or more other inverting surfactants, an amount of breaker may be present that is effective to achieve a desirable concentration of any or all of the one or more inverting surfactants.

In some embodiments, a tallow amine ethoxylate includes a compound of Formula I:

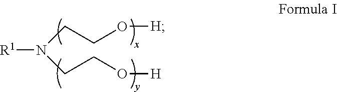

wherein R¹ is (i) derived from tallow, or (ii) selected from the group consisting of a C₁₀-C₂₀ hydrocarbyl, a C₁₄-C₁₈ hydrocarbyl, and

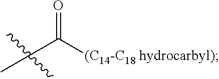

and wherein X and Y, independently, are 1 to 20.

The tallow of R¹ may be derived from one or more fatty acids selected from the group consisting of oleic acid, palmitic acid, stearic acid, myristic acid, and linoleic acid. In some embodiments, the tallow amine ethoxylate includes polyoxyethylene oleic amine, polyoxyethylene palmitic amine, polyoxyethylene stearic amine, polyoxyethylene myristic amine, polyoxyethylene linoleic amine, or a combination thereof.

In some embodiments, the tallow amine ethoxylate has an HLB-value of about 9 to about 16, about 10 to about 16, about 11 to about 16, about 12 to about 16, about 13 to about 16, about 14 to about 16, about 9 to about 15, about 9 to about 14, about 9 to about 13, about 9 to about 12, or about 9 to about 11. The tallow amine ethoxylate may be nonionic.

In some embodiments, the tallow amine ethoxylate includes TAM-2, TAM-5, TAM-8, TAM-10, TAM-15, TAM-20, or a combination thereof.

When used herein with regard to the selection of a variable (for example X and Y), the term “independently” indicates that two differently labeled variables selected from the same group may be the same or different (e.g., X and Y of formula (I) may both be selected from “1-20”, and the number selected for X and Y may be the same or different).

The phrases “C₁₀-C₂₀ hydrocarbyl,” “C₁₄-C₁₈ hydrocarbyl”, and the like, as used herein, generally refer to aliphatic, aryl, or arylalkyl groups containing 10 to 20 carbon atoms, or 14 to 18 carbon atoms, respectively, including substituted derivatives thereof. Examples of aliphatic groups, in each instance, include, but are not limited to, an alkyl group, a cycloalkyl group, an alkenyl group, a cycloalkenyl group, an alkynyl group, an alkadienyl group, a cyclic group, and the like, and includes all substituted, unsubstituted, branched, and/or linear analogs or derivatives thereof, in each instance having, for example, 10 to 20 total carbon atoms or 14 to 18 total carbon atoms for a “C₁₀-C₂₀ hydrocarbyl” and “C₁₄-C₁₈ hydrocarbyl”, respectively. Examples of alkyl groups include, but are not limited to, decyl, undecyl, and dodecyl. Additional examples of alkyl moieties have linear, branched and/or cyclic portions (e.g., 1-ethyl-4-methyl-cyclohexyl). Representative alkenyl moieties include, but are not limited to, 1-decenyl, 2-decenyl, and 3-decenyl. Representative alkynyl moieties include, but are not limited to, 1-decynyl, 2-decynyl and 9-decynyl. Examples of aryl or arylalkyl moieties include, but are not limited to, anthracenyl, azulenyl, biphenyl, fluorenyl, indan, indenyl, naphthyl, phenanthrenyl, phenyl, 1,2,3,4-tetrahydro-naphthalene, anthracenyl, and the like, including any heteroatom substituted derivative thereof.

Unless otherwise indicated, the term “substituted,” when used to describe a chemical structure or moiety, refers to a derivative of that structure or moiety wherein (i) a multi-valent non-carbon atom (e.g., oxygen, nitrogen, sulfur, phosphorus, etc.) is bonded to one or more carbon atoms of the chemical structure or moiety (e.g., a “substituted” C₄ hydrocarbyl may include, but is not limited to, a pyrimidinyl moiety, a pyridinyl moiety, a dioxanyl moiety, a diethyl ether moiety, a methyl propionate moiety, an N,N-dimethylacetamide moiety, a butoxy moiety, etc., and a “substituted” aryl C₁₂ hydrocarbyl may include, but is not limited to, an oxydibenzene moiety, a benzophenone moiety, etc.) or (ii) one or more of its hydrogen atoms (e.g., chlorobenzene may be characterized generally as an aryl C₆ hydrocarbyl “substituted” with a chlorine atom) is substituted with a chemical moiety or functional group such as acyl, alcohol, alkoxy, alkanoyloxy, alkoxycarbonyl, alkenyl, alkyl (e.g., methyl, ethyl, propyl, t-butyl), alkynyl, alkylcarbonyloxy (—OC(O)alkyl), amide (—C(O) NH-alkyl- or -alkylNHC(O)alkyl), primary, secondary, and tertiary amino (such as alkylamino, arylamino, arylalkylamino), aryl, arylalkyl, aryloxy, azo, azido, carbamoyl (—NHC(O)O-alkyl- or —OC(O)NH-alkyl), carbamyl (e.g., CONH₂, as well as CONH-alkyl, CONH-aryl, and CONH-arylalkyl), carboxyl, carboxylic acid, cyano, cycloalkyl, cycloalkenyl, ester, ether (e.g., methoxy, ethoxy), halo, haloalkyl (e.g., —CCl₃, —CF₃, —C(CF₃)₃), haloalkoxy, trihalomethanesulfonyl, trihalomethanesulfonamido, heteroalkyl, heterocycloalkyl, heteroaryl, heteroarylalkyl, isocyanate, isothiocyanate, nitrile, nitro, oxo, phosphodiester, silyl, sulfide, sulfonamido (e.g., SO₂NH₂), sulfone, sulfenyl, sulfinyl, sulfonyl (including alkylsulfonyl, arylsulfonyl and arylalkylsulfonyl), sulfoxide, thiocarbonyl, thiocarbamyl, thiocyanato, thiol (e.g., sulfhydryl, thioether) or urea (—NHCONH-alkyl-).

### Polymers

As used herein, the terms “polymer,” “polymers,” “polymeric,” and similar terms are used in their ordinary sense as understood by one skilled in the art, and thus may be used herein to refer to or describe a molecule (or group of such molecules), such as a macromolecule, that includes (i.e., is formed of) recurring units. Polymers may be formed in various ways, including by polymerizing monomers and/or by chemically modifying one or more recurring units of a precursor polymer.

A polymer may be a “homopolymer”, which includes substantially identical repeat units formed by polymerizing a particular monomer. A polymer may also be a “copolymer” comprising two or more different recurring units formed, for example, by copolymerizing two or more different monomers, and/or by chemically modifying one or more repeat units of a precursor polymer. The term “polymer” as used herein is intended to include both the acid form of the polymer as well as its various salts.

The repeat units of polymers may be described in various ways herein. For example, if a polymer includes an “acrylamide repeat unit” or the like, then the polymer includes a repeat unit derived from the polymerization of acrylamide, which is a monomer. As a further example, if a polymer includes an “acrylamide monomer”, then the polymer includes a repeat unit derived from the polymerization of acrylamide, which is a monomer. As yet another example, if a polymer include a repeat unit “derived from a monomer” (e.g., “derived from acrylamide”), then the repeat unit is the polymerized form of the monomer (e.g., “acrylamide”).

In some embodiments, the polymer is a friction-reducing polymer. The phrase “friction reducing polymer” refers to a polymer that reduces energy losses due to friction between an aqueous fluid in turbulent flow and tubular goods, e.g. pipes, coiled tubing, and the like, and/or subterranean formation. The friction reducing polymer is not intended to be limited to any particular type and may be synthetic polymers, natural polymers, or viscoelastic surfactants. The friction reducing polymers may be anionic, cationic, amphoteric or non-ionic depending on desired application. In addition, various combinations can be used including but not limited to hydrophilic/hydrophobic combinations, functionalized natural and/or synthetic blends of the above, or the like. The friction reducing polymers may be anionic, cationic, amphoteric or non-ionic depending on desired application. In addition, various combinations can be used including but not limited to hydrophilic/hydrophobic combinations, functionalized natural and/or synthetic blends of the above, or the like.

In some embodiments, the polymer is a polymer useful in emulsion compositions or an emulsion polymer.

In some embodiments, the polymer is a polymer useful for enhanced oil recovery applications. The phrase “enhanced oil recovery” or “EOR” (also known as tertiary mineral oil production) refers to a process for mineral oil production in which an aqueous injection fluid comprising at least a water soluble polymer is injected into a mineral oil deposit. The techniques of tertiary mineral oil production include what is known as “polymer flooding”. Polymer flooding involves injecting an aqueous solution of a water-soluble thickening polymer through the injection boreholes into the mineral oil deposit. As a result of the injection of the polymer solution, the mineral oil is forced through the cavities in the formation, proceeding from the injection borehole, in the direction of the production borehole, and the mineral oil is produced through the production borehole. By virtue of the fact that the polymer formulation has an increased viscosity as compared to the viscosity of water, the risk is reduced that the polymer formulation breaks through to the production borehole. Therefore, it is possible to mobilize additional mineral oil in the formation. Details of polymer flooding and of polymers suitable for this purpose are disclosed, for example, in “Petroleum, Enhanced Oil Recovery, Kirk-Othmer, Encyclopedia of Chemical Technology, online edition, John Wiley & Sons, 2010”. For polymer flooding, a multitude of different water-soluble thickening polymers have been proposed, especially high molecular weight polyacrylamide, copolymers of acrylamide and further comonomers, for example vinylsulfonic acid or acrylic acid. Polyacrylamide may be partly hydrolyzed polyacrylamide, in which some of the acrylamide units have been hydrolyzed to acrylic acid. It is known in the art to use inverse emulsions of polyacrylamide (co) polymers for enhanced oil recovery (EOR) in particular for use on off-shore platforms. Such inverse emulsions typically comprise about 30 wt. % of polymers. For use, inverse emulsions are diluted (i.e., “inverted”) with water to the final concentration of the polymer.

The polymer generally may be present in the compositions at any effective concentration. For example, a polymer may be present in a composition, such as an emulsion (e.g., an inverse emulsion) at an amount of about 1% to about 40%, about 10% to about 40%, about 20% to about 40%, about 30% to about 40%, about 1% to about 30%, about 1% to about 20%, or about 1% to about 10%, by weight, based on the weight of the composition.

In some embodiments, the polymer is water soluble.

In some embodiments, the polymer includes a repeat unit that includes a sulfonic acid moiety or a sulfonate moiety. The repeat unit that includes the sulfonic acid moiety or the sulfonate moiety may be present in the polymer at any mol %. In some embodiments, the repeat unit that includes the sulfonic acid moiety or the sulfonate moiety is present in the polymer at a mol % of about 0.1 to about 50, about 1 to about 50, about 1 to about 40, about 1 to about 30, about 1 to about 20, about 1 to about 10, about 2 to about 8, about 3 to about 7, or about 5.

In some embodiments, the repeat unit that includes a sulfonic acid moiety or a sulfonate moiety is derived from a monomer selected from the group consisting of acrylamide tertiary butyl sulfonic acid (ATBS), vinylsulfonic acid, allylsulfonic acid, 2-acrylamido-2-methylpropanesulfonic acid, 2-methacrylamido-2-methylpropanesulfonic acid, 2-acrylamidobutanesulfonic acid, 3-acrylamido-3-methylbutanesulfonic acid, and 2-acrylamido-2,4,4-trimethylpentanesulfonic acid.

In some embodiments, the polymers include a repeat unit derived from an acrylamide monomer, and at least one other type of repeat unit, such as a repeat unit derived from acrylic acid, and/or a repeat unit that includes a sulfonic acid moiety or a sulfonate moiety. An acrylamide repeat unit may be present at any mol % in a polymer. In some embodiments, an acrylamide repeat unit is present in the polymer at a mol % of about 50 to about 99.9, about 60 to about 90, about 60 to about 80, about 70 to about 80, or about 75. An acrylic acid repeat unit may be present at any mol % in a polymer. In some embodiments, an acrylic acid monomer is present in the polymer at a mol % of about 1 to about 40, about 5 to about 35, about 10 to about 30, about 15 to about 25, or about 20.

In some embodiments, the polymer includes acrylamide and one or more monomers selected from the group consisting of acrylic acid and its salts, methacrylamide, methacrylic acid and its salts, maleic acid and its salts, methyl acrylate, ethyl acrylate, propyl acrylate, methyl methacrylate, ethyl methacrylate, dimethylaminoethyl acrylate and its methylchloride and methosulfate quaternaries, dimethylaminoethyl methacrylate and its methylchloride and methosulfate quaternaries, diethylaminoethyl acrylate and its methylchloride and methosulfate quaternaries, diethylaminoethyl methacrylate and its methylchloride and methosulfate quaternaries, hydroxyethyl acrylate, hydroxyethyl methacrylate, styrene, acrylonitrile, 2-acrylamido-2-methylpropane sulfonic acid and its salts, 3-(methylacrylamido)-propyltrimethylammonium chloride, dimethylaminopropylmethacrylamide, isopropylaminopropylmethacrylamide, methacrylamidopropylhydroxyethyldimethylammonium acetate, vinyl methyl ether, vinyl ethyl ether, alkali metal and ammonium salts of vinyl sulfonic acid, vinyl pyridine, vinyl pyrrolidone, vinyl imidazole, diallyldimethylammonium chloride, styrene sulfonic acid and its salts, and the like.

Additionally or alternatively, the polymer may include one or more repeat units derived from one or more monomers selected from the group consisting of acrylic acid, methacrylic acid, crotonic acid, itaconic acid, maleic acid, fumaric acid, monomers comprising phosphonic acid groups (e.g., vinylphosphonic acid, allylphosphonic acid, N-(meth)acrylamidoalkylphosphonic acids, (meth)acryloyloxyalkylphosphonic acids), hydroxyethyl(meth)acrylate, hydroxypropyl(meth)acrylate, allyl alcohol, hydroxyvinyl ethyl ether, hydroxyl vinyl propyl ether, hydroxyvinyl butyl ether or polyethyleneoxide(meth)acrylates, monomers having ammonium groups (e.g., 3-trimethylammonium propylacrylamides, 2-trimethylammonium ethyl(meth)acrylates, 3-trimethylammonium propylacrylamide chloride (DIMAPAQUAT), 2-trimethylammonium ethyl methacrylate chloride (MADAME-QUAT)), monomers which may cause hydrophobic association of the (co) polymers, N-alkyl acrylamides, N-alkyl quaternary acrylamides, salts of the foregoing, or a combination of the foregoing.

The polymer of the compositions may be in any physical form. In some embodiments, the polymer is in form of particles. The particles may be of any size, but, in some embodiments, the particles of the polymer have an average particle size of about 0.05 μm to about 30 μm, about 3 μm to about 18 μm, about 0.4 μm to about 5 μm, or about 0.5 μm to about 4 μm, or about 0.5 μm to about 2 μm; wherein the phrase “average particle size” refers to the d50 value of the particle size distribution (number average).

The polymer generally may have any molecular weight (Mw). In some embodiments, the polymer has a weight average molecular weight of greater than about 5,000,000 Dalton, or greater than about 10,000,000 Dalton, or greater than about 15,000,000 Dalton, or greater than about 20,000,000 Dalton; or greater than about 25,000,000 Dalton.

### Hydrophobic Liquid

Any hydrophobic liquid may be used in the compositions and methods provided herein. The hydrophobic liquid may be referred to as a water-immiscible liquid.

The hydrophobic liquid may include an organic hydrophobic liquid. The hydrophobic liquid may include an aliphatic hydrocarbon, an aromatic hydrocarbon (e.g., toluene, xylene, etc.), or a combination thereof. Non-limiting examples of hydrophobic liquids include a paraffin hydrocarbon (e.g., saturated, linear, or branched), a naphthenic hydrocarbon, an olefin, an oil (e.g., a vegetable oil, such as soybean oil, rapeseed oil, canola oil, etc., and any other oil produced from the seed of any of several varieties of the rapeseed plant), a stabilizing surfactant, or a combination thereof.

The hydrophobic liquid may have a boiling point of at least 100° C., at least 135° C., or at least 180° C. (if the hydrophobic liquid has a boiling range, the phrase “boiling point” refers to the lower limit of the boiling range).

A hydrophobic liquid may be present in the compositions provided herein at any amount. For example, if a composition is an inverse emulsion (i.e., a water-in-oil emulsion), then the hydrophobic liquid may be present at an amount effective to form a continuous phase in which water or aqueous content is dispersed. As a further example, if a composition is an oil-in-water emulsion, then the hydrophobic liquid may be present at an amount effective to ensure that water or the aqueous content of a composition forms a continuous phase in which the hydrophobic liquid is dispersed.

### Emulsifier Surfactant

The compositions herein, such as the emulsions, may include an emulsifier surfactant. The emulsifier surfactants typically promote the formation and/or stabilization of water-in-oil emulsions. Normally, such emulsifiers have HLB values in the range of about 2 to about 10, preferably less than about 7.

An emulsifier surfactant may be present in a composition, such as a water-in-oil emulsion, at any amount. In some embodiments, the emulsifier surfactant is present in an emulsion at a concentration of about 0.1% to about 10%, about 0.1% to about 5%, or about 0.1% to about 1%, by weight, based on the weight of the emulsion.

Non-limiting examples of emulsifier surfactants include a sorbitan ester, an ethoxylated fatty alcohol with 1 to 4 ethyleneoxy groups, a phthalic ester, a fatty acid glyceride, a glycerine ester, a sorbitan monooleate, the reaction product of oleic acid and isopropanolamide, hexadecyl sodium phthalate, decyl sodium phthalate, sorbitan stearate, ricinoleic acid, hydrogenated ricinoleic acid, glyceride monoester of lauric acid, glyceride monoester of stearic acid, glycerol diester of oleic acid, glycerol triester of 12-hydroxystearic acid, glycerol triester of ricinoleic acid, an ethoxylated version of the foregoing comprising 1 to 10 moles of ethylene oxide per mole of the basic emulsifier, a modified polyester surfactant, an anhydride substituted ethylene copolymer, an N,N-dialkanol substituted fatty amide, and a combination thereof.

### Chain Transfer Agent

The compositions herein may include a chain transfer agent. A chain transfer agent may be present at any concentration. In some embodiments, a chain transfer agent is present at a concentration of about 1 ppm to about 5,000 ppm, about 1 ppm to about 4,000 ppm, about 1 ppm to about 3,000 ppm, or about 1 ppm to about 2,000 ppm of the emulsion.

A chain transfer agent may include any of those known in the art. Non-limiting examples of chain transfer agents include propylene glycol, isopropanol, 2-mercaptoethanol, sodium hypophosphite, dodecyl mercaptan, and thioglycolic acid.

### Inverted Emulsion

Also provided herein are inverted emulsions. The inverted emulsions may include any of the emulsions provided herein, such as the water-in-oil emulsions, and an additional amount of water.

As used herein, “inverted” means that a composition provided herein, such as an emulsion, is dispersed in an aqueous liquid, so that the dispersed polymer phase of the emulsion becomes a substantially continuous phase, and the hydrophobic liquid phase becomes a dispersed, discontinuous phase. The inversion point can be characterized as the point at which the viscosity of the inverted polymer solution has substantially reached its maximum under a given set of conditions. In practice, this may be determined for example by measuring viscosity of the composition periodically over time and when three consecutive measurements are within the standard of error for the measurement, then the solution is considered inverted.

In the inverted emulsions, a polymer may be present at any concentration. In some embodiments, a polymer is present in an inverted emulsion at a concentration of about 50 ppm to about 15,000 ppm, about 50 ppm to about 10,000 ppm, about 50 ppm to about 5,000 ppm, about 50 ppm to about 3,000 ppm, about 50 ppm to about 2,000 ppm, about 50 ppm to about 1,000 ppm, about 100 ppm to about 1,000 ppm, or about 500 ppm to about 1,000 ppm.

### Water

The water of an emulsion, such as a water-in-oil emulsion, and an additional amount of water of an inverted emulsion may be the same or different types of water. The water and/or the additional amount of water may include produced water, fresh water, salt water (e.g., sea water), or a combination thereof. The salt water may include a brine, such as a naturally-occurring brine. The brine may be a chloride-based, bromide-based, formate-based, or acetate-based brine that includes monovalent cations, polyvalent cations, or a combination thereof.

Water generally may be present at any amount in the emulsions provided herein, including, for example, the water-in-oil emulsions, dewatered emulsions, or inverted emulsions.

In some embodiments, water is present in an emulsion, such as a water-in-oil emulsion, dewatered emulsion, etc., at an amount of about 0.1% to about 40%, about 0.1% to about 30%, about 0.1% to about 20%, about 0.1% to about 15%, about 0.1% to about 12%, about 0.1% to about 10%, about 0.1% to about 6%, about 0.1% to about 5%, or about 1% to about 40%, about 10% to about 40%, or about 20% to about 40%, by weight, based on the weight of the emulsion. In some embodiments, water is present in an emulsion, such as a water-in-oil emulsion, dewatered emulsion, etc. at an amount of 12%, by weight, or less, or an amount of 10%, by weight, or less.

In some embodiments, in an inverted emulsion, water and an additional amount of water are present in the inverted emulsion at a total amount of at least 90 wt %, at least 95 wt %, or at least 98%, based on the weight of the inverted emulsion.

In some embodiments, the water and/or the additional amount of water includes about 15,000 mg/L to about 300,000 mg/L, about 15,000 mg/L to about 250,000 mg/L, about 15,000 mg/L to about 200,000 mg/L, about 15,000 mg/L to about 160,000 mg/L, about 15,000 mg/L to about 100,000 mg/L, about 15,000 mg/L to about 50,000 mg/L, about 30,000 mg/L to about 40,000 mg/L, or about 15,000 mg/L to about 16,000 mg/L total dissolved solids (tds).

### Methods of Treating Subterranean Formations

Also provided herein are methods of treating a subterranean formation. In some embodiments, the methods include providing a treatment fluid that includes any of the inverted emulsion disclosed herein; and injecting the treatment fluid into the subterranean formation. The injecting of the treatment fluid may be performed at a pressure effective to create one or more fractures in the subterranean formation.

In some embodiments, an inverted emulsion achieves a friction reduction that is at least 12 percentage points, at least 15 percentage points, or at least 18 percentage points greater than a comparative friction reduction achieved by a comparative inverted emulsion comprising a comparative breaker comprising 30%, by weight, or less of a tallow amine ethoxylate, based on the weight of the comparative breaker.

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

While certain aspects of conventional technologies have been discussed to facilitate disclosure of various embodiments, applicants in no way disclaim these technical aspects, and it is contemplated that the present disclosure may encompass one or more of the conventional technical aspects discussed herein.

The present disclosure may address one or more of the problems and deficiencies of known methods and processes. However, it is contemplated that various embodiments may prove useful in addressing other problems and deficiencies in a number of technical areas. Therefore, the present disclosure should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

In the descriptions provided herein, the terms “includes,” “is,” “containing,” “having,” and “comprises” are used in an open-ended fashion, and thus should be interpreted to mean “including, but not limited to.” When compositions or methods are claimed or described in terms of “comprising” various steps or components, the compositions or methods can also “consist essentially of” or “consist of” the various steps or components, unless stated otherwise.

The terms “a,” “an,” and “the” are intended to include plural alternatives, e.g., at least one. For instance, the disclosure of “a hydrophobic liquid”, “a polymer”, and the like, is meant to encompass one, or mixtures or combinations of more than one hydrophobic liquid, polymer, and the like, unless otherwise specified.

Various numerical ranges may be disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. Moreover, all numerical end points of ranges disclosed herein are approximate. As a representative example, Applicant discloses, in some embodiments, that the monomer comprising the sulfonic acid moiety or the sulfonate moiety is present in the polymer at a mol % of about 20 to about 30. This range should be interpreted as encompassing a mol % of about 20 and about 30, and further encompasses each of 21 mol %, 22 mol %, 23 mol %, 24 mol %, 25 mol %, 26 mol %, 27 mol %, 28 mol %, and 29 mol %, including any ranges and sub-ranges between any of these values.

As used herein, the term “about” means plus or minus 10% of the numerical value of the number with which it is being used.

### Embodiments

The following is a non-limiting listing of embodiments of the disclosure.

Embodiment 1. A composition, such as an emulsion or an emulsion precursor, comprising, consisting essentially of, or consisting of water, a hydrophobic liquid, a polymer, and, a breaker comprising, consisting essentially of, or consisting of one or more inverting surfactants, wherein the one or more inverting surfactants comprises, consists essentially of, or consists of a tallow amine ethoxylate.

Embodiment 2. The composition of Embodiment 1, wherein the emulsion is a water-in-oil emulsion (i.e., an inverse emulsion).

Embodiment 3. The composition of Embodiment 1 or 2, wherein the emulsion is a dewatered emulsion.

Embodiment 4. The composition of Embodiment 1, wherein the emulsion or the emulsion precursor has an aqueous/organic (A/O) ratio of about 2 to about 4, about 2.5 to about 3.5, about 2.5 to about 3, or about 2.8 to about 2.9.

### Breaker/Tallow Amine Ethoxylate

Embodiment 5. The composition of any of the preceding Embodiments, wherein (i) the tallow amine ethoxylate is present in the breaker at an amount of at least 30%, at least 35%, at least 40%, at least 45%, at least 50%, at least 60%, at least 70%, at least 80%, at least 90%, or at least 95%, by weight, based on the weight of the breaker, (ii) the tallow amine ethoxylate is present in the composition at an amount of about 1% to about 15%, about 2.5% to about 15%, about 1% to about 10%, about 2.5% to about 10%, or about 2.5% to about 5%, by weight, based on the weight of the composition, or (iii) a combination thereof.

Embodiment 6. The composition of any of the preceding Embodiments, wherein the breaker (i) consists of the tallow amine ethoxylate, (ii) does not include a PEG monooleate, an ethoxylated sorbitol ester, and/or an ethoxylated alcohol, or (iii) a combination thereof.

Embodiment 7. The composition of any of the preceding Embodiments, wherein the breaker is present in the composition at an amount of about 1% to about 50%, about 1% to about 40%, about 2.5% to about 40%, about 1 to about 30%, about 2.5% to about 30%, about 1% to about 20%, about 2.5% to about 20%, about 1% to about 15%, about 2.5% to about 15%, about 1% to about 10%, about 2.5% to about 10%, about 1% to about 5%, about 2.5% to about 5%, or about 1% to about 3%, by weight, based on the weight of the composition.

Embodiment 8. The composition of any of the preceding Embodiments, wherein the tallow amine ethoxylate comprises, consists essentially of, or consists of a compound of Formula I:

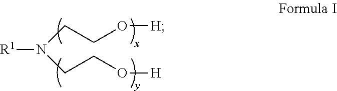

wherein R¹ is (i) derived from tallow, or (ii) selected from the group consisting of a C₁₀-C₂₀ hydrocarbyl, a C₁₄-C₁₈ hydrocarbyl, and

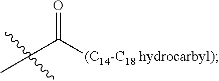

and wherein X and Y, independently, are 1 to 60, 1 to 40, 1 to 20, 2 to 20, 4 to 20, 6 to 20, 8 to 20, 10 to 20, 12 to 20, 14 to 20, 16 to 20, 18 to 20, 1 to 18, 1 to 16, 1 to 14, 1 to 12, 1 to 10, 1 to 8, 1 to 6, 1 to 4, or 1 to 2.

Embodiment 9. The composition of any of the preceding Embodiments, wherein the tallow of R¹ is derived from one or more fatty acids selected from the group consisting of oleic acid, palmitic acid, stearic acid, myristic acid, and linoleic acid.

Embodiment 10. The composition of any of the preceding Embodiments, wherein the tallow amine ethoxylate comprises, consists essentially of, or consists of polyoxyethylene oleic amine, polyoxyethylene palmitic amine, polyoxyethylene stearic amine, polyoxyethylene myristic amine, polyoxyethylene linoleic amine, or a combination thereof.

Embodiment 11. The composition of any of the preceding Embodiments, wherein the tallow amine ethoxylate has an HLB-value of about 9 to about 16, about 10 to about 16, about 11 to about 16, about 12 to about 16, about 13 to about 16, about 14 to about 16, about 9 to about 15, about 9 to about 14, about 9 to about 13, about 9 to about 12, or about 9 to about 11.

Embodiment 12. The composition of any of the preceding Embodiments, wherein the tallow amine ethoxylate comprises, consists essentially of, or consists of TAM-2, TAM-5, TAM-8, TAM-10, TAM-15, TAM-20, TAM-25, or a combination thereof.

Embodiment 13. The composition of any of the preceding Embodiments, wherein the tallow amine ethoxylate is nonionic.

Embodiment 14. The composition of any of the preceding Embodiments, wherein the breaker comprises one or more additional inverting surfactants.

Embodiment 15. The composition of any of the preceding Embodiments, wherein the one or more additional inverting surfactants is a molecule or composition having a hydrophilic-lipophilic balance (HLB) of greater than 10.

Embodiment 16. The composition of any of the preceding Embodiments, wherein the one or more additional inverting surfactants comprises one or more of polyoxyethylene sorbitol tetraoleate, polyethylene glycol monoleate, ethoxylated alcohols, such as C₁₂₋₁₄ branched ethoxylated alcohol, ethoxylated octyl and nonyl phenols, ethoxylated nonyl phenol formaldehyde resin, polyethylene oxide esters of fatty acids, or dioctyl esters of sodium sulfosuccinate.

### Polymer

Embodiment 17. The composition of any of the preceding Embodiments, wherein the polymer is a homopolymer (i.e., consists of one type of repeat unit) or a copolymer (i.e., comprises of two or more different types of repeat unit), and is present in the composition at an amount of about 1% to about 40%, about 10% to about 40%, about 20% to about 40%, about 30% to about 40%, about 1% to about 30%, about 1% to about 20%, or about 1% to about 10%, by weight, based on the weight of the composition.

Embodiment 18. The composition of any of the preceding Embodiments, wherein the polymer is a friction reducing polymer.

Embodiment 19. The composition of any of the preceding Embodiments, wherein the polymer is water soluble.

Embodiment 20. The composition of any of the preceding Embodiments, wherein the polymer comprises a repeat unit comprising a sulfonic acid moiety or a sulfonate moiety.

Embodiment 21. The composition of any of the preceding embodiments, wherein the repeat unit comprising the sulfonic acid moiety or the sulfonate moiety is present in the polymer at a mol % of about 0.1 to about 50, about 1 to about 50, about 1 to about 40, about 1 to about 30, about 1 to about 20, about 1 to about 10, about 2 to about 8, about 3 to about 7, or about 5.

Embodiment 22. The composition of any of the preceding Embodiments, wherein the repeat unit comprising a sulfonic acid moiety or a sulfonate moiety is a repeat unit derived from a monomer selected from the group consisting of acrylamide tertiary butyl sulfonic acid (ATBS), vinylsulfonic acid, allylsulfonic acid, 2-acrylamido-2-methylpropanesulfonic acid, 2-methacrylamido-2-methylpropanesulfonic acid, 2-acrylamidobutanesulfonic acid, 3-acrylamido-3-methylbutanesulfonic acid, and 2-acrylamido-2,4,4-trimethylpentanesulfonic acid.

Embodiment 23. The composition of any of the preceding Embodiments, wherein the polymer comprises an acrylamide repeat unit, an acrylic acid repeat unit, or a combination hereof.

Embodiment 24. The composition of any of the preceding Embodiments, wherein the acrylamide repeat unit is present in the polymer at a mol % of about 50 to about 99.9, about 60 to about 90, about 60 to about 80, about 70 to about 80, or about 75.

Embodiment 25. The composition of any of the preceding Embodiments, wherein the acrylic acid repeat unit is present in the polymer at a mol % of about 1 to about 40, about 5 to about 35, about 10 to about 30, about 15 to about 25, or about 20.

Embodiment 26. The composition of any of the preceding Embodiments, wherein the polymer comprises an acrylamide repeat unit, an acrylic acid repeat unit, and an acrylamide tertiary butyl sulfonic acid (ATBS) repeat unit.

Embodiment 27. The composition of any of the preceding Embodiments, wherein the repeat units of the polymer comprise, consists essentially of, or consist of one or more repeat units derived from a monomer selected from the group consisting of acrylic acid, methacrylic acid, crotonic acid, itaconic acid, maleic acid, fumaric acid, repeat units comprising phosphonic acid groups (e.g., vinylphosphonic acid, allylphosphonic acid, N-(meth)acrylamidoalkylphosphonic acids, (meth)acryloyloxyalkylphosphonic acids), hydroxyethyl(meth)acrylate, hydroxypropyl(meth)acrylate, allyl alcohol, hydroxyvinyl ethyl ether, hydroxyl vinyl propyl ether, hydroxyvinyl butyl ether or polyethyleneoxide(meth)acrylates, repeat units having ammonium groups (e.g., 3-trimethylammonium propylacrylamides, 2-trimethylammonium ethyl(meth)acrylates, 3-trimethylammonium propylacrylamide chloride (DIMAPAQUAT), 2-trimethylammonium ethyl methacrylate chloride (MADAME-QUAT)), repeat units which may cause hydrophobic association of the (co) polymers, N-alkyl acrylamides, N-alkyl quaternary acrylamides, salts of the foregoing, or a combination of the foregoing.

Embodiment 28. The composition of any of the preceding Embodiments, wherein the polymer comprises a repeat unit derived from acrylamide, and one or more repeat units derived from a monomer selected from the group consisting of acrylic acid and its salts, methacrylamide, methacrylic acid and its salts, maleic acid and its salts, methyl acrylate, ethyl acrylate, propyl acrylate, methyl methacrylate, ethyl methacrylate, dimethylaminoethyl acrylate and its methylchloride and methosulfate quaternaries, dimethylaminoethyl methacrylate and its methylchloride and methosulfate quaternaries, diethylaminoethyl acrylate and its methylchloride and methosulfate quaternaries, diethylaminoethyl methacrylate and its methylchloride and methosulfate quaternaries, hydroxyethyl acrylate, hydroxyethyl methacrylate, styrene, acrylonitrile, 2-acrylamido-2-methylpropane sulfonic acid and its salts, 3-(methylacrylamido)-propyltrimethylammonium chloride, dimethylaminopropylmethacrylamide, isopropylaminopropylmethacrylamide, methacrylamidopropylhydroxyethyldimethylammonium acetate, vinyl methyl ether, vinyl ethyl ether, alkali metal and ammonium salts of vinyl sulfonic acid, vinyl pyridine, vinyl pyrrolidone, vinyl imidazole, diallyldimethylammonium chloride, styrene sulfonic acid and its salts, and the like.

Embodiment 29. The composition of any of the preceding Embodiments, wherein the polymer is in the form of particles.

Embodiment 30. The composition of any of the preceding Embodiments, wherein the particles of the polymer have an average particle size of about 0.05 μm to about 30 μm, about 3 μm to about 18 μm, about 0.4 μm to about 5 μm, or about 0.5 μm to about 4 μm, or about 0.5 μm to about 2 μm; wherein the phrase “average particle size” refers to the d50 value of the particle size distribution (number average).

Embodiment 31. The composition of any of the preceding Embodiments, wherein the polymer has a weight average molecular weight (Mw) of greater than about 5,000,000 Dalton, or greater than about 10,000,000 Dalton, or greater than about 15,000,000 Dalton, or greater than about 20,000,000 Dalton; or greater than about 25,000,000 Dalton.

### Hydrophobic Liquid

Embodiment 32. The composition of any of the preceding Embodiments, wherein the hydrophobic liquid comprises, consists essentially of, or consists of an organic hydrophobic liquid.

Embodiment 33. The composition of any of the preceding Embodiments, wherein the hydrophobic liquid has a boiling point of at least 100° C., at least 135° C., or at least 180° C. (if the hydrophobic liquid has a boiling range, the phrase “boiling point” refers to the lower limit of the boiling range).

Embodiment 34. The composition of any of the preceding Embodiments, wherein the hydrophobic liquid comprises an aliphatic hydrocarbon, an aromatic hydrocarbon (e.g., toluene, xylene, etc.), or a combination thereof.

Embodiment 35. The composition of any of the preceding Embodiments, wherein the hydrophobic liquid comprises, consists essentially of, or consists of a paraffin hydrocarbon (e.g., saturated, linear, or branched), a naphthenic hydrocarbon, an olefin, an oil (e.g., a vegetable oil, such as soybean oil, rapeseed oil, canola oil, etc., and any other oil produced from the seed of any of several varieties of the rapeseed plant), a stabilizing surfactant, or a combination thereof.

### Emulsifier Surfactant

Embodiment 36. The composition of any of the preceding Embodiments, wherein the emulsion further comprises an emulsifier surfactant.

Embodiment 37. The composition of any of the preceding Embodiments, wherein the emulsifier surfactant is present in the emulsion at a concentration of about 0.1% to about 10%, about 0.1% to about 5%, or about 0.1% to about 1%, by weight, based on the weight of the emulsion.

Embodiment 38. The composition of any of the preceding embodiments, wherein the emulsifier surfactant is selected from the group consisting of a sorbitan ester, an ethoxylated fatty alcohol with 1 to 4 ethyleneoxy groups, a phthalic ester, a fatty acid glyceride, a glycerine ester, a sorbitan monooleate, the reaction product of oleic acid and isopropanolamide, hexadecyl sodium phthalate, decyl sodium phthalate, sorbitan stearate, ricinoleic acid, hydrogenated ricinoleic acid, glyceride monoester of lauric acid, glyceride monoester of stearic acid, glycerol diester of oleic acid, glycerol triester of 12-hydroxystearic acid, glycerol triester of ricinoleic acid, an ethoxylated version of the foregoing comprising 1 to 10 moles of ethylene oxide per mole of the basic emulsifier, a modified polyester surfactant, an anhydride substituted ethylene copolymer, an N,N-dialkanol substituted fatty amide, and a combination thereof.

### Chain Transfer Agent

Embodiment 39. The composition of any of the preceding embodiments, further comprising a chain transfer agent.

Embodiment 40. The composition of any of the preceding embodiments, wherein the chain transfer agent is present at a concentration of about 1 ppm to about 5,000 ppm, about 1 ppm to about 4,000 ppm, about 1 ppm to about 3,000 ppm, or about 1 ppm to about 2,000 ppm of the emulsion.

Embodiment 41. The composition of any of the preceding embodiments, wherein the chain transfer agent is selected from the group consisting of propylene glycol, isopropanol, 2-mercaptoethanol, sodium hypophosphite, dodecyl mercaptan and thioglycolic acid.

### Inverted Emulsion

Embodiment 42. An inverted emulsion comprising, consisting essentially of, or consisting of the composition (e.g., inverse emulsion) of any of the preceding Embodiments, and an additional amount of water.

Embodiment 43. The inverted emulsion of any of the preceding embodiments, wherein the polymer is present in the inverted emulsion at a concentration of about 50 ppm to about 15,000 ppm, about 50 ppm to about 10,000 ppm, about 50 ppm to about 5,000 ppm, about 50 ppm to about 3,000 ppm, about 50 ppm to about 2,000 ppm, about 50 ppm to about 1,000 ppm, about 100 ppm to about 1,000 ppm, or about 500 ppm to about 1,000 ppm.

### Water

Embodiment 44. The composition or the inverted emulsion of any of the preceding Embodiments, wherein the water of the composition and the additional amount of water of the inverted emulsion are the same or different types of water.

Embodiment 45. The composition (e.g., inverse emulsion or dewatered emulsion) of any of the preceding Embodiments, wherein water is present in the emulsion at an amount of at an amount of about 0.1% to about 40%, about 0.1% to about 30%, about 0.1% to about 20%, about 0.1% to about 15%, about 0.1% to about 12%, about 0.1% to about 10%, about 0.1% to about 5%, or about 1% to about 40%, about 10% to about 40%, or about 20% to about 40%, by weight, based on the weight of the composition.

Embodiment 46. The composition (e.g., inverse emulsion or dewatered emulsion) of any of the preceding Embodiments, wherein water is present at an amount of 6%, by weight, or less, or about 1% to about 6%, by weight, based on the weight of the emulsion; or wherein water is present at an amount of 12%, by weight, or less, or about 1% to about 12%, by weight, based on the weight of the emulsion; or wherein water is present at an amount of 10%, by weight, or less, or about 1% to about 10%, by weight, based on the weight of the emulsion.

Embodiment 47. The inverted emulsion of any of the preceding Embodiments, wherein the water and the additional amount of water are present in the inverted emulsion at a total amount of at least 90 wt %, at least 95 wt %, or at least 98%, based on the weight of the inverted emulsion.

Embodiment 48. The composition or the inverted emulsion of any of the preceding Embodiments, wherein the water and/or the additional amount of water comprises, consists essentially of, or consists of produced water, fresh water, salt water (e.g., sea water), or a combination thereof.

Embodiment 49. The composition or the inverted emulsion of any of the preceding Embodiments, wherein the salt water comprises a brine, such as a naturally-occurring brine.

Embodiment 50. The composition or the inverted emulsion of any of the preceding Embodiments, wherein the brine is a chloride-based, bromide-based, formate-based, or acetate-based brine comprising monovalent cations, polyvalent cations, or a combination thereof.

Embodiment 51. The composition or the inverted emulsion of any of the preceding Embodiments, wherein the water and/or the additional amount of water comprises about 15,000 mg/L to about 300,000 mg/L, about 15,000 mg/L to about 250,000 mg/L, about 15,000 mg/L to about 200,000 mg/L, about 15,000 mg/L to about 160,000 mg/L, about 15,000 mg/L to about 100,000 mg/L, about 15,000 mg/L to about 50,000 mg/L, about 30,000 mg/L to about 40,000 mg/L, or about 15,000 mg/L to about 16,000 mg/L total dissolved solids (tds).

### Methods of Treating Subterranean Formations

Embodiment 52. A method of treating a subterranean formation, the method comprising, consisting essentially of, or consisting of providing a treatment fluid comprising the inverted emulsion of any of the preceding Embodiments; and injecting the treatment fluid into the subterranean formation.

Embodiment 53. The method of any of the preceding Embodiments, wherein the injecting of the treatment fluid is performed at a pressure effective to create one or more fractures in the subterranean formation.

Embodiment 54. The method of any of the preceding Embodiments, wherein the inverted emulsion achieves a friction reduction that is at least 12 percentage points, at least 15 percentage points, or at least 18 percentage points greater than a comparative friction reduction achieved by a comparative inverted emulsion comprising a comparative breaker comprising 30%, by weight, or less of a tallow amine ethoxylate, based on the weight of the comparative breaker.

### Inverting Packages

Embodiment 55. An inverting package comprising, consisting essentially of, or consisting of the breaker of any of the preceding Embodiments.

### Concentrations

Embodiment 56. The composition, inverted emulsion, or method of any of the preceding Embodiments, wherein (i) the tallow amine ethoxylate is present in the breaker at an amount of at least 30%, at least 35%, at least 40%, at least 45%, at least 50%, at least 60%, at least 70%, at least 80%, at least 90%, or at least 95%, by weight, based on the weight of the breaker, (ii) the tallow amine ethoxylate is present in the composition at an amount of about 1% to about 15%, about 2.5% to about 15%, about 1% to about 10%, about 2.5% to about 10%, or about 2.5% to about 5%, by weight, based on the weight of the composition, (iii) the breaker is present in the composition at an amount of about 1% to about 50%, about 1% to about 40%, about 2.5% to about 40%, about 1 to about 30%, about 2.5% to about 30%, about 1% to about 20%, about 2.5% to about 20%, about 1% to about 15%, about 2.5% to about 15%, about 1% to about 10%, about 2.5% to about 10%, about 1% to about 5%, about 2.5% to about 5%, or about 1% to about 3%, by weight, based on the weight of the composition, or (iv) any combination thereof.

### Examples

The present disclosure is further illustrated by the following examples, which are not to be construed in any way as imposing limitations upon the scope thereof. On the contrary, it is to be clearly understood that resort may be had to various other aspects, embodiments, modifications, and equivalents thereof which, after reading the description herein, may suggest themselves to one of ordinary skill in the art without departing from the spirit of the present disclosure or the scope of the appended claims. Thus, other aspects of this disclosure will be apparent to those skilled in the art from consideration of the specification and practice of the embodiments disclosed herein.

### Example 1—Preparation of Emulsions

In this example, anionic emulsion polymerizations were performed to produce emulsion precursors, which were used in the following examples. The emulsions of this example are described at Table 1, but it should be noted that the amount of chain transfer agent (CTA) may vary from 0 to about 2,000 ppm, and the amount of stabilizer may range from about 5 wt % to about 6 wt %.

TABLE 1
Formulation

| | |
|---|---|
| PZN batch solids in initial emulsion | 28.82% |
| A/O ratio (aqueous/organic) | 2.871 |
| D40 Oil | 8.80% |
| poly(stearylmethacrylate-co-methacrylic | 5.34% |
| acid) stabilizer | |
| Post-add D40 | 14.0% |
| Isopropanol (IPA) | 1500 ppm |
| Acrylamide AMD mol % | 75% |
| Acrylic acid AA mol % | 20% |
| Na-ATBS mol % | 5% |

In this example, the pH of the formulations was adjusted to 6.37 with post-homogenization BV (cP) (03/12=2830, 03/30=1524, 03/60=1004) and initial NaAC actives=25.89% or initial AA polymer actives=24.43%. The polymerization produced the emulsion precursor at SV=9.0 cP, 0.2% BV (02/30)=649 cP, ratio of 0.2% BV/SV=72% and final NaAc actives=50%.

The dewatering of this example was conducted with a distillation under conditions of vacuum 4 Torr and temperature 75° C.

### Comparative Example 2—Addition of Breaker

In this example, a breaker having the composition provided at Table 2 was added to a dewatered emulsion of Example 1. After its addition, the breaker was present in the composition at an amount of 6%, by weight, based on the weight of the composition. A propeller mixer was used to mix the dewatered emulsion and the breaker.

TABLE 2
Breaker of Comparative Example 2

| | Weight percent |
|---|---|
| | (% ) (based on |
| Composition | weight of breaker) |
| PEG 400 Monoleate | 51.5 |
| Ethoxylated Tallow Amine (TAM-8) | 26.4 |
| Ethoxylated sorbitol esters | 14.7 |
| Alcohols C11-C15, secondary | 7.4 |
| ethoxylated (Tergitol 15-S-9) | |

### Example 3—Addition of Breaker

In this example, TAM-5 was added as a breaker to a dewatered emulsion of Example 1. After its addition, TAM-5 was present in the composition at an amount of 6%, by weight, based on the weight of the composition. A propeller mixer was used to mix the dewatered emulsion, and no gelation was observed.

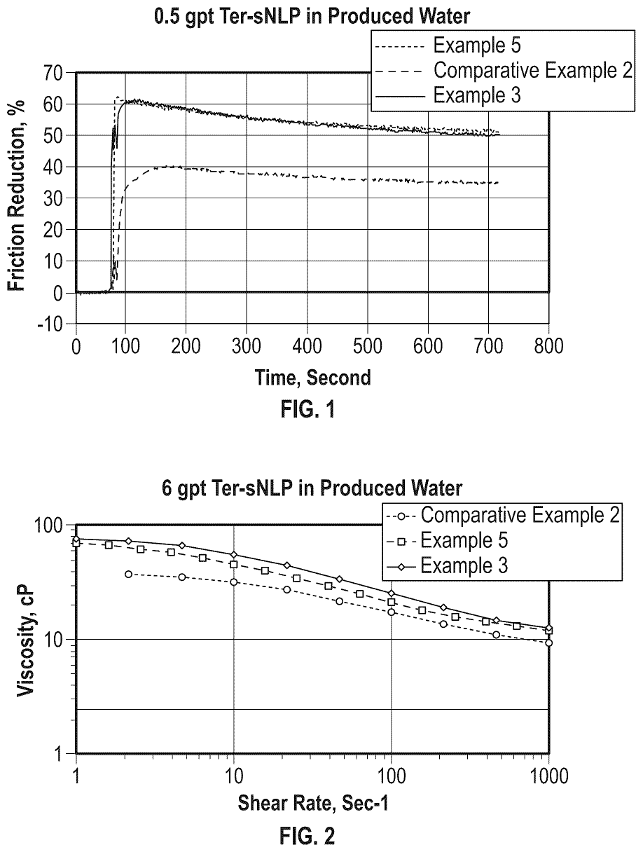

The results of the tests explained below, including the results of FIG. 1 and FIG. 2, demonstrated that the emulsion of this example achieved both fast inversion and friction reduction.

### Example 4—Performance of Friction Reduction

Friction reduction measurements were performed on a laboratory scale friction loop designed to simulate well fracturing flow conditions. The results are depicted at FIG. 1.

The friction loop simulated the field conditions to the maximum known extent (Reynolds number: 128,000). The main components of the friction loop included a pump, magnetic flow meter, and a differential pressure transmitter to create and monitor necessary conditions. All pipes and other components were constructed using stainless steel 316L/304L material.

To test the friction reduction property of the materials, the friction loop reservoir was filled with 20 L of the produced water. The produced water had the components described in Table 3.

TABLE 3
Components of Produced Water

| | | Weight |
|---|---|---|
| Salt | (%) | (g/20 L) |
| NaCl | 17.128 | 3425.64 |
| KCl | 0.183 | 36.611 |
| MgCl₂ | 0.356 | 71.16 |
| CaCl₂ | 0.828 | 165.55 |
| BaCl₂ | 0 | 0.077 |
| Na₂SO₄ | 0.104 | 20.807 |
| NaHCO₃ | 0.022 | 4.433 |
| FeCl₂ | 0.01 | 1.95 |

| | |
|---|---|
| TDS | 182,354 |

This brine was then recirculated through the friction loop at a flow rate of 24 gallons per minute across a five-foot section of half-inch diameter pipe (which was required to generate the above mentioned Reynolds number). The baseline pressure drop was measured. The exemplary materials were then added at 0.5 gpt to the recirculating brine solution. The degree of friction reduction (% Frₜ) at a given time ‘t’ was calculated from the initial pressure drop ΔPᵢ and the pressure drop at time t, ΔPₜ using the equation:

$$\% {Fr}_{t} = \frac{Δ {P}_{i} - Δ {P}_{t}}{Δ {P}_{i}} \times 100$$

Solution Viscosities-Viscosities of the solutions were measured on an Anton Paar MCR 302 rheometer with a double gap cell DG26.7 at 25° C. FIG. 2 depicts a plot of viscosity v. shear rate for embodiments of compositions herein.

Dissolution of examplesDissolution of examples was performed on a high speed blender. 350 mL of produced water (see Table 3) was first loaded in the container of a Chandler Model 3260 Constant Speed Mixer. The mixer was then operated at 1500 rpm. Then, 1.05 mL slurry (equivalent to 3 gallons per thousand (gpt)) was injected with a plastic syringe. Dissolution took about 260 seconds. The solutions from the dissolution operation were then transferred to the viscosity measurements.

### Example 5—Prehydrated Concentrate Solution

This example was a prehydrated concentrate solution of Comparative Example 2, which provided an indication of the highest possible friction reduction. The prehydration of this example was performed with a long gentle sharing. To minimize possible degradation, which can be caused by mechanical action, a concentrated solution of 10 gpt of the comparative example in the produced water (see Table 3) was prepared with an overhead stirrer.

First, 350 mL of the produced water was loaded into a 600 mL glass beaker. A 3-arm PTFE propeller stirrer was then immersed in the produced water, followed by rotation at 200 rpm. A 3.5 mL sample was then injected into the produced water within 30 seconds with a plastic syringe. Agitation was kept at 200 rpm for 4 hours.

Any dilution from the prehydrate solution for the viscosity measurements was conducted with a magnetic stirrer for at least one hour.

In the friction reduction measurement, an equivalent amount of the prehydrated solution that made a 0.5 gpt sample in 20 L produced water was weighed and introduced into the friction reduction test loop.

### Example 6—Testing of TAM-2, TAM-5, TAM-10, and TAM-20

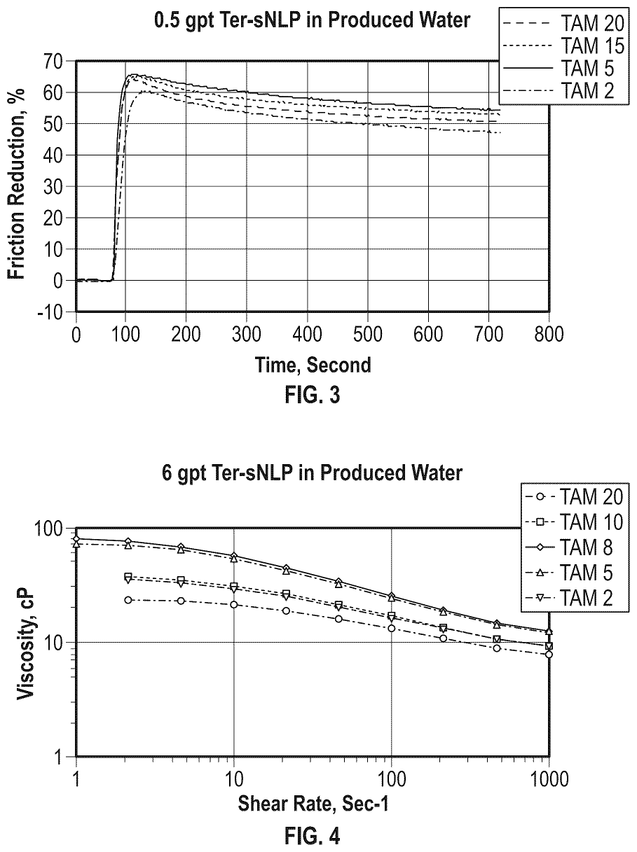

Examples 3 and 4 were repeated and augmented by testing TAM-2, TAM-10, and TAM-20. FIG. 3 depicts the test results of the friction reduction tests in the produced water. FIG. 4 depicts the test results of the flow profiles in the produced water.

1. A composition comprising:
water;
a hydrophobic liquid;
a polymer comprising two or more different repeat units; and
a breaker comprising one or more inverting surfactants;
wherein the one or more inverting surfactants comprises a tallow amine ethoxylate;
wherein the two or more different repeat units comprise a repeat unit comprising a sulfonic acid moiety or a sulfonate moiety; and
wherein—
(i) the breaker is present in the composition at an amount of about 2.5% to about 50%, by weight, based on the weight of the composition, or
(ii) the tallow amine ethoxylate is present in the breaker at an amount of at least 30%, by weight, based on the weight of the breaker, or
(iii) the tallow amine ethoxylate is present in the composition at an amount of about 2.5% to about 15%, by weight, based on the weight of the composition, or
(iv) a combination thereof.

2. The composition of claim 1, wherein the tallow amine ethoxylate is present in the breaker at an amount of at least 90%, by weight, based on the weight of the breaker.

3. The composition of claim 1, wherein the tallow amine ethoxylate comprises a compound of Formula I: 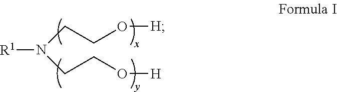
wherein R¹ is selected from the group consisting of a C₁₄-C₁₈ hydrocarbyl and 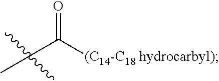
and
wherein X and Y, independently, are 1 to 20.

4. The composition of claim 1, wherein the tallow amine ethoxylate has an HLB-value of about 9 to about 16.

5. The composition of claim 1, wherein the tallow amine ethoxylate comprises TAM-2, TAM-5, TAM-8, TAM-10, TAM-15, TAM-20, or a combination thereof.

6. The composition of claim 1, wherein the repeat unit comprising a sulfonic acid moiety or a sulfonate moiety is derived from a monomer selected from the group consisting of acrylamide tertiary butyl sulfonic acid (ATBS), vinylsulfonic acid, allylsulfonic acid, 2-acrylamido-2-methylpropanesulfonic acid, 2-methacrylamido-2-methylpropanesulfonic acid, 2-acrylamidobutanesulfonic acid, 3-acrylamido-3-methylbutanesulfonic acid, and 2-acrylamido-2,4,4-trimethylpentanesulfonic acid.

7. The composition of claim 1, wherein the repeat unit comprising the sulfonic acid moiety or the sulfonate moiety is present in the polymer at a mol % of about 0.1 to about 50.

8. The composition of claim 1, wherein the two or more different repeat units further comprise an acrylamide repeat unit, an acrylic acid repeat unit, or a combination hereof.

9. The composition of claim 8, wherein the acrylamide repeat unit is present in the polymer at a mol % of about 50 to about 99.9.

10. The composition of claim 1, further comprising a chain transfer agent, wherein the chain transfer agent is present in the composition at a concentration of about 1 ppm to about 2,000 ppm.

11. An inverted emulsion comprising:
the composition of claim 1; and
an additional amount of water;
wherein the polymer comprising two or more different repeat units is present in the inverted emulsion at a concentration of about 50 ppm to about 15,000 ppm.

12. The inverted emulsion of claim 11, wherein the additional amount of water comprises a brine.

13. A method of treating a subterranean formation, the method comprising:
providing a treatment fluid comprising the inverted emulsion of claim 11; and
injecting the treatment fluid into the subterranean formation.

14. The method of claim 13, wherein the injecting of the treatment fluid is performed at a pressure effective to create one or more fractures in the subterranean formation.

15. The method of claim 13, wherein the inverted emulsion achieves a friction reduction that is at least 12 percentage points greater than a comparative friction reduction achieved by a comparative inverted emulsion comprising a comparative breaker comprising 30%, by weight, or less of a tallow amine ethoxylate, based on the weight of the comparative breaker.
